(19) United States
(12) Patent Application Publication
(10) Pub. No.: US 2006/0160402 A1
(43) Pub. Date: Jul. 20, 2006

(54) Power limited circuit cable for plenum applications in a constant current lighting system

(76) Inventors: Wayne James Kowalski, Buffalo Grove, IL (US); Philip Peterson, Salem, WI (US)

Correspondence Address: PATZIK, FRANK & SAMOTNY LTD., 150 SOUTH WACKER DRIVE, SUITE 900, CHICAGO, IL, 60606, US

(21) Appl. No.: 11/321,808

(22) Filed: Dec. 29, 2005

Related U.S. Application Data
(60) Provisional application No. 60/639,977, filed on Dec. 29, 2004.

(51) Int. Cl. H01R 4/24

(52) U.S. Cl. 439/397

(57) ABSTRACT

A power limited circuit cable for plenum applications in a constant current lighting system comprises a twisted pair cable or a parallel pair cable, a ground conductor, a housing comprising a first compartment for the ground conductor and a second compartment for the twisted pair cable or parallel pair cable, a first dielectric layer disposed between the twisted pair cable or parallel pair cable and the housing of the first compartment and a web portion disposed between the first and second compartments of the housing. The plenum cable has a capacitance between the first and second conductor of the twisted pair cable or parallel pair cable and the ground conductor is 19±3 pF/ft at a frequency of 1 KHz.

### PRIORITY INFORMATION

This application claims priority to provisional patent application Ser. No. 60/639,977 filed on Dec. 29, 2004.

### FIELD OF THE INVENTION

The present invention relates to cables that are constructed for use in constant current lighting systems and more particularly to a cable rated for plenum applications comprising a multi-compartment housing for twisted pair conductors or parallel pair conductors and a ground lead, wherein the twisted pair conductors and ground conductor are separated within the housing.

### BACKGROUND OF THE INVENTION

The National Electrical Code defines three classes of circuits and provides specific installation requirements for each. In general, Class 1 is used to classify circuits that provide output that is not power limited; Class 2 comprises any circuit that provides 30V or less at 100 VA; and Class 3 comprises any circuit that provides up to 150V at 100 VA.

Typically, traditional lighting systems consist of permanently wired-in lighting fixtures, with each lighting fixture obtaining its power directly from a regular Class 1 power line. Because a regular power line is not power limited and is considered large enough to be a fire-hazard, the National Electrical Code classifies these traditional lighting systems as Class 1 circuits and requires numerous protective measures. For example, traditional lighting systems are required to have electrical conductors that are installed in the form of armored cable or within steel conduits.

A traditional lighting system may have a number of lighting troffers connected in parallel to each other. Each troffer typically includes a ballast and is connected to a junction box by a whip. Each junction box is then connected to an ordinary power outlet via cable housed within a steel conduit. In another traditional lighting system, a plurality of recessed light fixtures is connected in series, each including a junction box connected to the fixture via a whip. Each junction box is in turn connected to an ordinary power outlet via conduit wire housed within a steel cable.

These, and other traditional lighting systems, exhibit a number of drawbacks. First by delivering a line voltage to each fixture, traditional lighting systems provide a shock hazard and thus present a significant danger during installations. In addition, components such as conduit and whips, which are required for Class 1 operation, are both costly and inflexible. For example, installation of steel conduit around obstructions can be time-consuming and last minute reconfigurations may be cumbersome.

Class 3 lighting systems address the drawbacks and shortcomings of the Class 1 systems described above. One example of a Class 3 lighting system comprises a power supply and at least one lamp driver. The power supply is designed to physically mount to a junction box and to convert the ordinary power line signal to a high frequency output signal (for example, 48 kHz), where the output of the power supply is provided at a substantially constant current level. To comply with Class 3 requirements, the power supply also includes circuitry to ensure that the power supply output signal is power limited to 100 VA. At least one lamp driver is mounted to a fixture and configured to receive the high-frequency output signal from the power supply. The lamp driver then uses the received power signal to operate one or more lamps. Each lamp driver is preferably connected to the power supply by a plenum rated Class 3 cable.

Plenum rated cables are approved by Underwriters Laboratories for non-conduit applications located in environmental air spaces. It is a low cost alternative to traditional conduit in many commercial installations because it is safe, easy to install and provides a significant cost savings over traditional conduit installations.

As with any cable used to transmit, electricity, digital signals, etc., the electrical characteristics of the plenum-rated cable affect the overall performance of the apparatus or system in which the cable is used. Capacitance refers to a cable's unique ability to store an electric charge and to resist sudden changes in the magnitude of that charge (voltage). In a twisted pair cable, it is found not only between the two wires of the twisted pair conductors, but also between adjacent conductors in the same cable. The capacitance between two adjacent conductors is called the mutual capacitance and is expressed in units of picofarads per foot (pF/ft). An example of the effects of capacitance on system performance is the use of a twisted pair cable in high frequency digital transmissions. Mutual capacitance distorts the normal square wave shape of the transmitted signal, causing errors in data transmissions. The larger the capacitance of the cable, the higher the distortion and error rate.

The present inventive power limited circuit cable for plenum applications in a constant current lighting system addresses the concerns and problems associated with enhancing the operation and efficiency of Class 3 lighting systems by maintaining a specific mutual capacitance in the cables interconnecting the components of the system conductors of the twisted pair conductor.

### SUMMARY OF THE INVENTION

The plenum cable of the present invention has a mutual capacitance and comprises a twisted pair cable comprising a first and second conductor and a dielectric layer surrounding each of the first and second conductors, the first and second conductors and corresponding dielectric layers being twisted substantially along the length of the cable; a ground conductor; a housing comprising a first compartment for the ground conductor and a second compartment for the twisted pair; and a first dielectric layer disposed between the twisted pair cable and the housing of the first compartment. The plenum cable further comprises a web portion disposed between the first and second compartments of the housing. The first and second conductors are composed of 18 AWG bare copper wire and the ground conductor is composed of 14 AWG bare copper wire. The present inventive cable has a mutual capacitance between the first and second conductor of the twisted pair cable and the ground conductor is 19±3 pF/ft at a frequency of 1 KHz.

### BRIEF DESCRIPTION OF THE DRAWINGS

FIG. 1 shows a front elevation view of a first and second preferred embodiment of the present inventive power limited circuit cable for plenum applications in a constant current lighting system;

FIG. 2 shows a lighting system in which the present inventive power limited circuit cable for plenum applications in a constant current lighting system is intended to be used; and

FIG. 3 shows another lighting system in which the present inventive power limited circuit cable for plenum applications in a constant current lighting system is intended to be used.

### DETAILED DESCRIPTION OF THE DRAWINGS

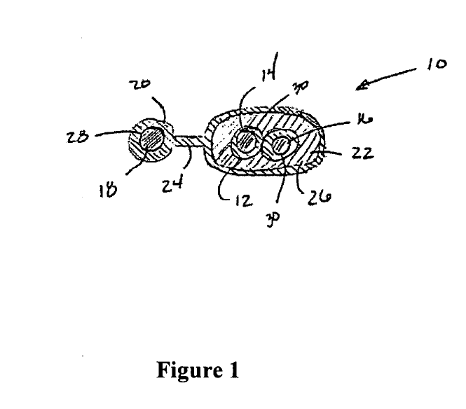

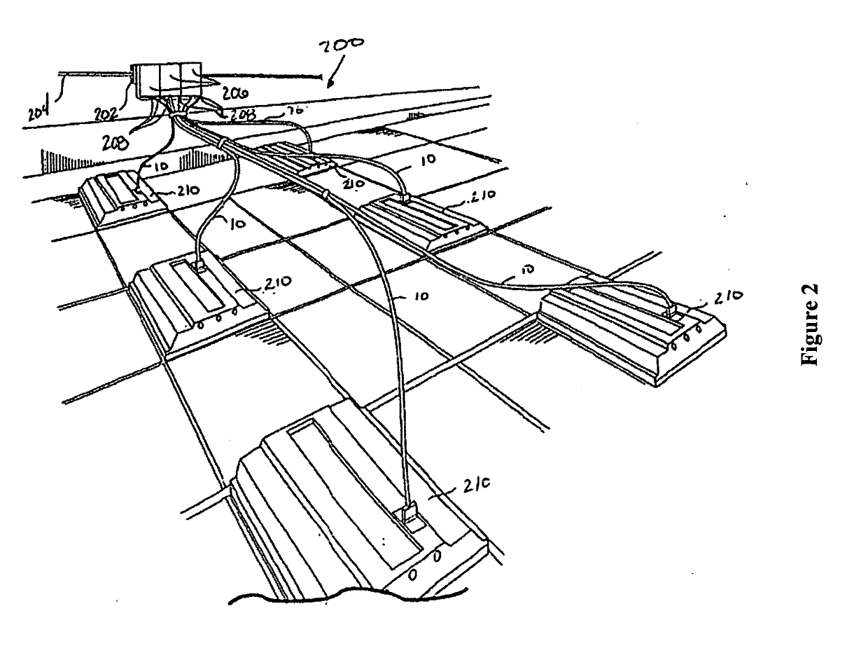

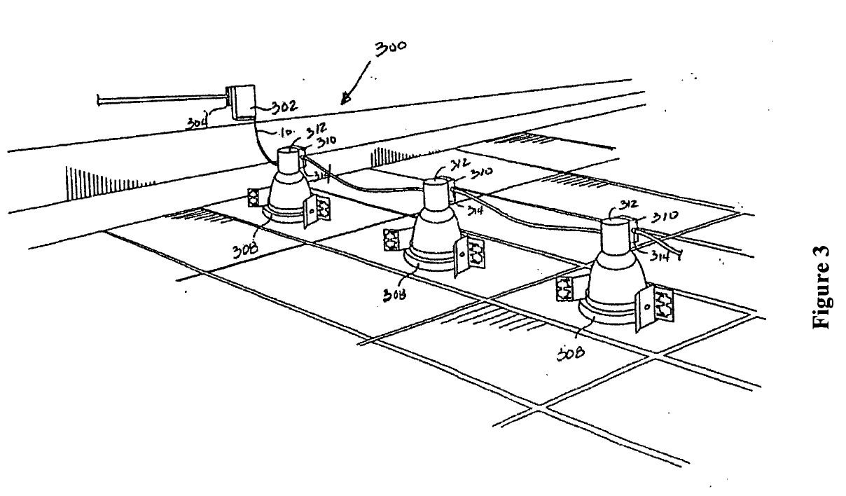

A constant current cable for plenum applications 10 according to the present invention is shown in FIG. 1 and will be described herein. The plenum cable 10 shown in FIG. 1 comprises a twisted pair cable 12, comprising a first and second conductor 14, 16, and a ground conductor 18, where the twisted pair cable 12 and ground conductor 18 are jacketed in a unitary housing 20. To ensure that a desired mutual capacitance is maintained in the conductors 14, 16 of the twisted pair cable 12, a first dielectric 22 or insulation layer provides separation between the twisted pair cable 12 and the housing 20. Additionally, the housing comprises a web portion 24 that is integrated into the housing 20, separating the housing into a first compartment 26 containing the twisted pair cable 12 and the first dielectric layer 22, and a second compartment 28 containing the ground conductor 18. The inventive cable 10 depicted in FIG. 1 is especially applicable for use in Class 3 constant current lighting systems, such as those shown in FIGS. 2 and 3.

FIG. 2 shows a lighting system 200 comprising a junction box 202 supplied with a power line signal (typically, either a 60 Hz @ 120V or 277V signal) through a pair of power line conductors and a safety ground via a steel armored conduit 204. First and second power supplies 206 are mounted to the junction box 202, with each power supply 206 operably connected to receive the power line signal and connect to the safety ground. Each of the power supplies 206 includes an output 208 for outputting the substantially constant current, high-frequency power line signal to operate a light fixture 210 that is mounted remotely from the power supply 206, e.g. more than 20 feet from the power supply 206.

The output 208 from each power supply 206 unit is power-limited to a maximum of 100 Volt-Ampere in accordance with specifications for Class 3 circuits (as defined by the National Electrical Code). Accordingly, the lighting system shown in FIG. 2 can be installed without conduit and connected to the light fixture 210 via a plug-in, light-weight flexible two-lead electrical cable 10, such as the inventive cable shown in FIG. 1. As shown in FIG. 2, each output port 208 is connected via the flexible cable 10 to a lamp driver (not shown in FIG. 2) associated with each lighting fixture 210. Although the power supplies 206 are shown with two output ports 208, each power supply may alternatively include only a single output port or more than two output ports.

Each output port 208 in the power supply 206 is also configured to physically receive and disconnectably connect electrically to a modular connector specially designed to mate with the inventive cable 10 shown in FIG. 1 and designed to connect the cable 10 to an output port 208. The other end of the flexible cable 10 also includes a modular connector configured to be physically and electrically received by one of the light fixtures 210. The modular connections between the cable 10, the power supplies 206 and light fixtures 210 are easily disconnected and reconnect enabling quicker installation, reconfiguration and replacement of the various components of the lighting system 200.

The lighting system 300 of FIG. 3 comprises a single power supply 302 connected to a junction box 304 to receive a power line signal. The power supply 302 is then connected, via a flexible cable 10, such as the inventive cable 10 shown in FIG. 1, to three recessed lighting fixtures 308. Each fixture 308 includes a lamp driver 310 mounted to the fixture housing 312. The lamp driver 310 may include as many as two ports 314. Each port 314 is capable of disconnectably receiving the flexible cable 10 and can be used either as an input port or an output port. Similar to the lighting system 200 shown in FIG. 2, each end of the flexible cable 10 is equipped with a modular connector specially designed to mate with the inventive cable 10 to enable the cable to disconnectably and electrically mate with the output port of the power supply 302 or the lamp driver ports 314.

Accordingly, unlike the lighting system 200 shown in FIG. 2, where each of the light fixtures 210 is connected to the power supply 206 in parallel (i.e. each fixture connected to an output port in the power supply), each of the lighting fixtures 308 shown in FIG. 3 is capable of being connected in series to one another enabling multiple lighting fixtures 308 to be operated from a single output port in the power supply 302. The specific number of light fixtures 308 that can be connected in series is based on the wattage of the lamp in each respective fixture and the power output from the power supply. For example, a 100 W power supply output may be used to power two 42 W lamps in series or three 26 W lamps in series.

The output from the power supply in these exemplary lighting systems is a substantially constant-current output signal, and remains relatively unchanged throughout a specific load impedance range. The magnitude of the constant-current output from the power supply may be chosen depending on the specific application and design of the lighting system and the lamps used in the system.

Each of the lighting systems shown in FIGS. 2 and 3 includes power limiting circuitry to maintain the electrical loads of the respective system within the parameters of Class 3. In a Class 3 lighting system the current is typically between approximately 0.67 Amps_{RMS} and 33 Amps_{RMS}. As an example, in one embodiment of these lighting systems, the constant current output is designed to be 1.3 Amps_{RMS} and the power supply is configured to operate with load impedances from 0 to 50 Ohms. Under these parameters, loading the loop with impedances between 0 and 58 Ohms could cause the output voltage to vary from 0 V_{RMS} to 75 V_{RMS}, and thus vary the output power from 0 VA to 100 VA, respectively. Accordingly, the power output of the supply would range from an essentially 0 VA short circuit, through the 100 VA maximum load for a Class 3 circuit. Compliance with Class 3 parameters, therefore, requires that the system be power limited when impedance conditions greater than 58 Ohms (including open circuit), and the system attempts to push output voltage greater than 75 V_{RMS} and when the power of the system is greater than 100 VA.

The cable shown in FIG. 1 is designed and adapted to function optimally within the electrical properties of the lighting systems depicted in FIGS. 2 and 3 and described herein and within the parameters of Class 3 systems. The inventive cable exhibits the following electrical properties:

| | |
|---|---|
| Temperature Rating | −20° C. to 60° C. |
| Operating Voltage | 300 V RMS Max |
| Capacitance between Twisted Pair | 19 ± 3 pF/ft |
| Conductors at 1 KHz | |

Turing back to FIG. 1, the unitary housing 20 is comprised of a low smoke polyvinylchloride (“PVC”) rated for plenum applications and includes a first and second compartment 26, 28. The first compartment 26 is adapted to hold the twisted pair cable or parallel pair cable 12 and first dielectric or insulation layer 22. The wall thickness of the PVC material in the first compartment 26 is approximately 0.024 inches.

The overall outside width of the first compartment 26 when a twisted pair cable 12 and first dielectric layer 22 are contained therein is approximately 0.160 inches. The second compartment 28 is adapted to hold the ground conductor 18 and has a wall thickness of approximately 0.018 inches. The overall outside width of the second compartment 28 is approximately 0.100 inches when the ground conductor 18 is contained therein.

A web portion 24 is integrated with the housing 20 to separate the first and second compartments 26, 28 and to assist in maintaining the desired mutual capacitance in the conductors 14, 16 of the twisted pair cable 12. The web portion 24 may be integrally formed when the first and second compartments 26, 28 are extruded from raw PVC material. Alternatively, the first and second compartments 26, 28 may be formed independently with the web portion 24 joined there between by any suitable means, such as by bonding, heat or adhesives. Preferably, the length of the web portion 24 is between 0.008 and 0.010 inches. The overall outside width of the inventive plenum cable 10 is approximately 0.350 inches.

The twisted pair cable 12 has a first and second conductor wire 14, 16 composed from approximately 18 AWG bare copper wire. Alternatively, the conductors 14, 16 are composed from any solid metal or suitable metallic material such as solid or strands of copper, metal coated substrate, silver, aluminum, steel, alloys or a combination, a plurality of metal strands, an appropriate fiber glass conductor, a layered metal or combination thereof. In the preferred embodiment of the present invention, the twisted pair cable 12 utilizes 18 AWG bare copper wire for the conductor wires 14, 16. However, a range of 12-18 AWG wire can be used without departing from the spirit of the invention.

Each conductor 14, 16 is surrounded by a cylindrical dielectric or insulation layer 30 and disposed centrally within and thus substantially concentric with the corresponding dielectric or insulation layer 30. The dielectric or insulation layer 30 may be any suitable material used in the insulation of cables such as foamed and non-foamed polyvinylchloride, polyethylene, polypropylene or fluoro-copolymers (such as TEFLON®, which is a registered trademark of DuPont), fluoropolymers (such as HALAR which is a trademark of Ausimont), cross-linked polyethylene, rubber, etc. Preferably, the twisted pair cable 12 used in the inventive plenum cable has a pair lay length of 0.75 inch to 1.25 inches per revolution.

The first and second conductors 14, 16 may be joined together by a number of means, including (1) a common dielectric layer wherein the first and second conductors are separated by a web portion connecting the sections of the dielectric layer, (2) independent dielectric layers are joined together by any suitable means along their lengths, or (3) a second dielectric layer jacketing the first dielectric layer, where either each conductor is jacketed by an independent, second dielectric layer and the dielectric layers are joined together by any suitable means along their lengths, or a unitary jacket of the second dielectric layer jackets the first and second conductors and corresponding first dielectric layers and includes a web portion separating the conductors. Any of these configurations is deemed suitable for use in the cable of the present invention.

A first dielectric or insulation layer 22 separates the twisted pair cable 12 and the housing wall 20 of the first compartment 26 to maintain the desired mutual capacitance, namely 19±3 pF/ft at 1 KHz, between the first and second conductors 14, 16 of the twisted pair 12. The first dielectric layer 22 is comprised of any suitable dielectric material possessing a low dielectric constant, preferably below 2.7. Suitable dielectric materials include foamed and non-foamed polyvinylchloride, polyethylene, polypropylene or fluoro-copolymers (such as TEFLON®, which is a registered trademark of DuPont), fluoropolymers (such as HALAR which is a trademark of Ausimont), cross-linked polyethylene, rubber, etc. It is contemplated that the first dielectric layer 22 be of a thickness ranging between 0.006 inches and 0.015 inches to maintain the desired mutual capacitance in the twisted pair cable 12.

The ground conductor 18 in the inventive cable 10 is preferably composed from a 14 AWG solid bare copper wire. However, the ground conductor can be composed from a wire of 12-18 AWG. Alternatively, the ground conductor 18 is composed of any solid metal or suitable metallic material such as solid or strands of copper, metal coated substrate, silver, aluminum, steel, alloys or a combination, a plurality of metal strands, an appropriate fiber glass conductor, a layered metal or combination thereof.

The inventive cable 10 of the present invention offers a number of advantages over previous technology for the applications described herein. As has been previously stated, the ground conductor 18 needs to be isolated from the conductors of the twisted pair cable 12 to minimize the impact of the ground conductor 18 on the mutual capacitance and inductance in the twisted pair cable 12. When this is accomplished by shielding the conductors 14, 16 of the twisted pair cable 12, the shielding material will increase the mutual capacitance in the twisted pair cable 12 and will shorten the usable length of the cable 10 or require an increase in power to overcome the effect.

As has also been previously discussed, to maintain a Class 3 rating, a lighting system must be power limited to 100 VA, thus limiting the amount of power that can be pushed through the cable 10. Similarly if the ground conductor is simply combined with the conductors 14, 16 of the twisted pair cable 12, the mutual capacitance would increase again requiring increased power to make up for the increase in capacitance. The inventive cable 10 addresses the issues of mutual capacitance, optimizes power requirements and allows for longer useable cable lengths by physically separating the ground conductor 18 from the conductors 14, 16 of the twisted pair cable 12 and providing the first dielectric layer 22 between the twisted pair cable 12 and housing 20.

The constant current cable for plenum applications 10 is manufactured through an extrusions process that utilizes two extrusion heads and/or two extruders. The twisted pair cable 12 is prepared for inclusion within the cable 10 by coating the twisted pair cable 12 with the first dielectric layer material 22. After the first dielectric layer 22 is appropriately sized to the desired dimension over the twisted pair cable 12, the low smoke PVC material of the unitary housing 20 is extruded over the insulated twisted pair cable 12 and ground conductor 18 in the desired thickness.

While the first and second conductors 14, 16 have been described herein as part of a twisted pair cable 12, it is also contemplated that the first and second conductors 14, 16 can be arranged as a parallel pair. The parallel pair offers the advantages of ease of production of the cable as well as ease of termination of the cable and attachment of connectors. When the parallel pair cable is used in place of twisted pair cable, the size of the first and second conductors 14, 16 and spacing from the ground conductor 18 will be augmented accordingly to maintain the desired capacitance of 19±3 pF/ft at 1 KHz. The preferred range of size of the first and second conductors 14, 16 remains 12-18 AWG. In addition, the concepts of spacing the first and second conductors apart from one another, as well as spacing the conductors apart from the ground conductor previously described with respect to the twisted pair conductors, apply to the parallel pair conductors described herein. Likewise, the ground conductor is preferably composed of a bare copper ranging from 12-18 AWG.

While the present inventive power limited circuit cable for plenum applications 10 has been described in connection with a constant current lighting system, this application is exemplary in nature and is not intended to be limiting on the possible applications for cables of these characteristics. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

We claim:

1. A plenum cable having a mutual capacitance, the plenum cable comprising:
a twisted pair cable comprising a first and second conductor and a dielectric layer surrounding each of the first and second conductors, the first and second conductors and corresponding dielectric layers being twisted substantially along the length of the cable;
a ground conductor;
a housing comprising a first compartment for the ground conductor and a second compartment for the twisted pair; and
a web portion disposed between the first and second compartments of the housing and adapted to separate the first and second compartments.

2. The cable of claim 1 wherein the housing is rated for plenum applications.

3. The cable of claim 1 wherein the first and second conductors are composed of approximately 18 AWG bare copper wire.

4. The cable of claim 1 wherein the first and second conductors are composed of bare copper wire ranging from 12-18 AWG.

5. The cable of claim 1 wherein the ground conductor is composed of approximately 14 AWG bare copper wire.

6. The cable of claim 1 wherein the ground conductor is composed of approximately 18 AWG bare copper wire.

7. The cable of claim 1 wherein the ground conductor is composed of bare copper wire having a size measurement ranging from 12-18 AWG.

8. The cable of claim 1 wherein the mutual capacitance between the first and second conductor of the twisted pair cable is 19±3 pF/ft at a frequency of 1 KHz.

9. The cable of claim 1 further comprising a first dielectric layer disposed between the twisted pair cable and the housing of the first compartment.

10. A cable for a lighting system comprising:
a twisted pair cable comprising a first and second conductor and a first dielectric layer surrounding each of the first and second conductors, the first and second conductors composed from an approximately 18 AWG copper wire, the first and second conductors and corresponding dielectric layers being twisted substantially along the length of the cable, the twisted pair cable having a mutual capacitance of 19±3 pF/ft at a frequency of 1 KHz;
a ground conductor, the ground conductor composed from an approximately 14 AWG copper wire; and
a housing comprising a first compartment for the ground conductor and a second compartment for the twisted pair.

11. The cable of claim 10 further comprising a web portion disposed between the first and second compartments of the housing, adapted to separate the first and second compartments.

12. The cable of claim 10 further comprising a first dielectric layer disposed between the twisted pair cable and the housing of the first compartment.

13. The cable of claim 10 wherein the housing is rated for plenum applications.

14. A plenum cable having a mutual capacitance, the plenum cable comprising:
a cable comprising a twisted pair cable or parallel pair cable, the cable comprising a first and second conductor and a dielectric layer surrounding each of the first and second conductors:
a ground conductor;
a housing comprising a first compartment for the ground conductor and a second compartment for the twisted pair cable or parallel pair cable; and
a first dielectric layer disposed between the twisted pair cable or parallel pair cable and the housing of the first compartment.

15. The cable of claim 14 further comprising a web portion disposed between the first and second compartments of the housing adapted to separate the first and second compartments.

16. The cable of claim 14 wherein the first and second conductors are composed of approximately 18 AWG bare copper wire.

17. The cable of claim 14 wherein the first and second conductors are composed of 12-18 AWG bare copper wire.

18. The cable of claim 14 wherein the ground conductor is composed of approximately 14 AWG bare copper wire.

19. The cable of claim 14 wherein the ground conductor is composed of approximately 18 AWG bare copper wire.

20. The cable of claim 14 wherein the ground conductor is composed of 12-18 AWG bare copper wire.

21. The cable of claim 14 wherein the mutual capacitance between the first and second conductor of the twisted pair cable is 19±3 pF/ft at a frequency of 1 KHz.

22. The cable of claim 14 wherein the housing is rated for plenum applications.

23. The cable of claim 14, the first and second conductors and corresponding dielectric layers of the twisted pair cable being twisted substantially along the length of the cable.
